(19) United States
(12) Patent Application Publication
(10) Pub. No.: US 2011/0318626 A1
(43) Pub. Date: Dec. 29, 2011

(54) BATTERY MODULE

(76) Inventor: Ursula Bartenschlager, Pfedelbach-Untersteinbach (DE)

(21) Appl. No.: 13/131,724

(22) PCT Filed: Nov. 19, 2009
(86) PCT No.: PCT/EP2009/065489

§ 371 Date: Jul. 5, 2011

(51) Int. Cl. H01M 10/50; B60H 1/32

(52) U.S. Cl. 429/120; 62/259.2; 62/239

(57) ABSTRACT

The invention relates to a battery module with a housing and at least one battery disposed in the housing. At least one element for cooling and/or heating the at least one battery is provided. According to the invention, the at least one element is embodied by at least one heat pipe for tempering the at least one battery.

The invention relates to a battery module as defined by the preamble to claim 1. The invention also relates to a battery module system and to a motor vehicle.

### PRIOR ART

Batteries, such as lithium-ion batteries or zebra batteries, supply various kinds of equipment, such as motor vehicles, hospitals or power drills, with electric current. Especially in lithium-ion batteries, a slight temperature difference of less than 4K is necessary. Also in lithium-ion batteries, the temperature should not be higher than 60° C. In general, a plurality of batteries are built in inside a housing, and a battery module is thus formed. Battery modules have the advantage that they can be cooled more easily, and higher levels of electric power can be attained in a simple way by the combination of a plurality of battery modules into a battery module system.

The batteries disposed in a battery module are tempered, that is, cooled or heated, by a flowing cooling fluid by means of convection, or in other words by mass transport. To that end, the battery module has at least one inlet opening and at least one outlet opening, through which the tempering fluid is carried in and out. For recirculating the tempering fluid, a fluid delivery device is needed, such as a blower for air as the tempering fluid. Thus recirculating the tempering fluid requires a high expenditure of energy, and furthermore, because of the moving mechanical parts of the fluid delivery device, damage can easily occur. When this kind of battery module is used, the spinning of a space station in space is adversely affected because of the rotating element in the gas delivery device.

### DISCLOSURE OF THE INVENTION

### Advantages of the Invention

A battery module according to the invention, including a housing, at least one battery disposed in the housing, and at least one means for tempering, that is, for cooling and/or heating, the at least one battery, in which the at least one means includes at least one heat-exchanger tube for conducting heat from and/or to the at least one battery.

A heat-exchanger tube is a heat transfer medium, which by using the heat of evaporation of a substance permits a high heat flow density; that is, over a small cross-sectional area, large quantities of heat can be transported. The heat resistance of a heat-exchanger tube is markedly lower than that of metals; as a result, heat-exchanger tubes behave virtually isothermally (with a constant temperature over the length of the heat-exchanger tube). For the same transferred heat, they are substantially lighter than conventional heat exchangers or heat transfer media, such as a plate heat transfer medium. By a suitable choice of the working medium of the heat-exchanger tube, the necessary ranges of use, that is, temperature ranges, for the battery modules can be attained. Thus a heat-exchanger tube can cool and/or heat the batteries of the battery module, or in other words temper the batteries of the battery module, simply, without moving mechanical parts. In an especially advantageous way, a fluid delivery device, such as a blower, for recirculating a tempering fluid and a flowing tempering fluid are no longer necessary.

In a further feature, between at least two batteries, there is at least one fin of a thermally conductive material, such as metal, in particular copper, and the at least one fin is connected thermally conductively to the at least one heat-exchanger tube. Between the batteries of the battery module, there are metal fins, especially of copper, which absorb the heat given off by the batteries at the surface and conduct it to the heat-exchanger tube. Conversely, the metal fins can also conduct to the batteries for heating the batteries.

In particular, at least two fins are connected thermally conductively to a plate of a thermally conductive material, such as metal, and the plate is connected thermally conductively to the at least one heat-exchanger tube. In the vicinity of the end of the fins, the fins are connected to the plate mechanically and thus also thermally conductively. Hence the plate thermally combines all the fins that are disposed between the batteries, and the heat-exchanger tube is disposed thermally conductively on the plate. The heat given off by the batteries is thus first conducted to the fins, then conducted from the fins to the plate and from the plate to the heat-exchanger tube, and vice versa.

In a further feature, the at least one battery in the housing is disposed in a preferably electrically nonconductive liquid for the mal conduction. The thermally conductive liquid inside the housing of the battery additionally increases the heat exchange between the batteries and from the batteries to the fins or the plate, so that the temperature difference between the batteries is slight, for instance less than 4K; that is, a homogeneous temperature distribution inside the battery module is ensured.

In an additional embodiment, the liquid is an oil, such as silicone oil.

Preferably, the housing at least partly comprises plastic or metal.

In a variant, the at least one battery is a lithium-ion battery.

Expediently, the at least one heat-exchanger tube is a heat pipe or a thermosiphon.

A battery module system according to the invention having a plurality of battery modules includes at least one described battery module.

In particular, at least two battery modules are connected thermally conductively to one another by means of the at least one heat-exchanger tube, for tempering, that is, for cooling and/or heating, the at least one battery. The battery modules of a battery module system are thus thermally conductively connected to the heat-exchanger tube, so that between the battery modules of the battery module system, an especially good heat exchange is possible, and as a result, even inside the battery module system, only temperature differences occur in the batteries or the battery modules.

A motor vehicle according to the invention includes at least one described battery module and/or one described battery module system.

In an additional variant, for cooling the at least one battery, the at least one heat-exchanger tube is or can be connected thermally conductively to a heat sink, and/or for heating the at least one battery, the at least one heat-exchanger tube is or can be connected thermally conductively to a heat source.

In a further variant, the heat sink is an evaporator of an air conditioning system and/or is a heat transfer medium for transferring heat to the ambient air and/or is a body of the motor vehicle. When an evaporator is used as a heat sink, the batteries can be cooled especially well, since low temperatures in the range of 3° C., for instance, occur at the evaporator, so that especially effective, rapid cooling of the batteries is possible by means of the heat-exchanger tube. By means of a heat transfer medium, such as cooling laminations, the heat conducted by the heat-exchanger tube can also be output to the ambient air. The body of the motor vehicle can also be considered for use as a heat sink, since because of the relatively large mass and surface area of the body, the quantities of heat occurring in battery modules can also be adequately output by the body. If the body is used as a heat sink, advantageously no additional devices, such as a separate heat transfer medium, are required.

In a further feature, the heat source is an electric heater and/or a heat transfer medium for transferring waste heat out of an internal combustion engine of the motor vehicle. By means of the electric heater, the batteries of the battery module or of the battery module system can be heated purposefully and quickly to the desired temperature. If the waste heat of the internal combustion engine of the motor vehicle is used for heating the batteries, advantageously no additional energy has to be expended for heating the battery. The heat from the internal combustion engine can be transferred for instance by a heat transfer medium to the heat-exchanger tube from the motor oil, cooling fluid, transmission fluid, or the waste gas.

In particular, the heat sink and/or the heat source is connectable thermally conductively to the at least one heat-exchanger tube by means of heat convection, for instance with a fluid circuit, so that the heat convection can preferably be switched on and off. When the heat is transferred from the heat sink and/or the heat source to the heat-exchanger tube or vice versa indirectly by means of a fluid circuit, it is advantageously possible, if a valve, for instance, is used inside the fluid circuit, for the heat transfer to be switched on and off in a purposeful way, so that purposeful control of the heating or cooling of the batteries of the battery module or of the battery module system is possible.

### BRIEF DESCRIPTION OF THE DRAWINGS

Below, two exemplary embodiments of the invention will be described in further detail in conjunction with the accompanying drawings. In the drawings:

FIG. 1 is a perspective view of a housing with fins of a battery module;

FIG. 2 is a perspective view of the housing of FIG. 1 with batteries;

FIG. 3 is a schematic section through the battery module with a heat-exchanger tube and two fluid circuits, in a first embodiment;

FIG. 4 is a schematic section through the battery module with the heat-exchanger tube and the fluid circuit, in a second embodiment;

FIG. 5 is a section through a battery module system with four battery modules; and

FIG. 6 is a side view of a motor vehicle with an internal combustion engine.

### EMBODIMENTS OF THE INVENTION

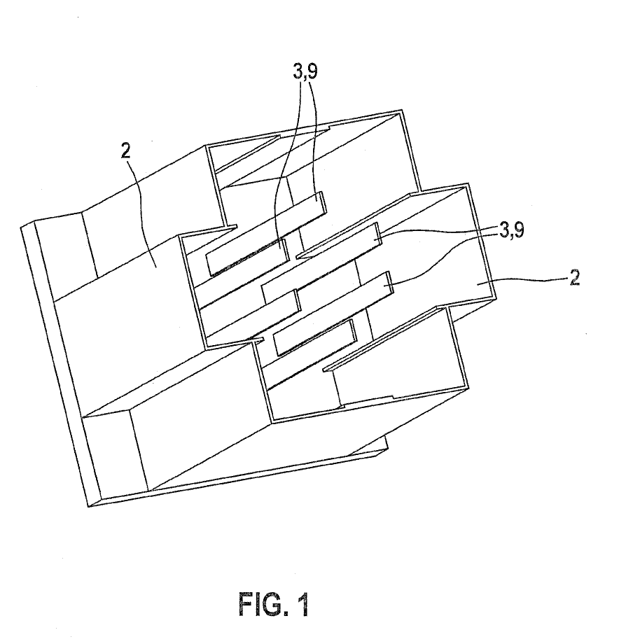

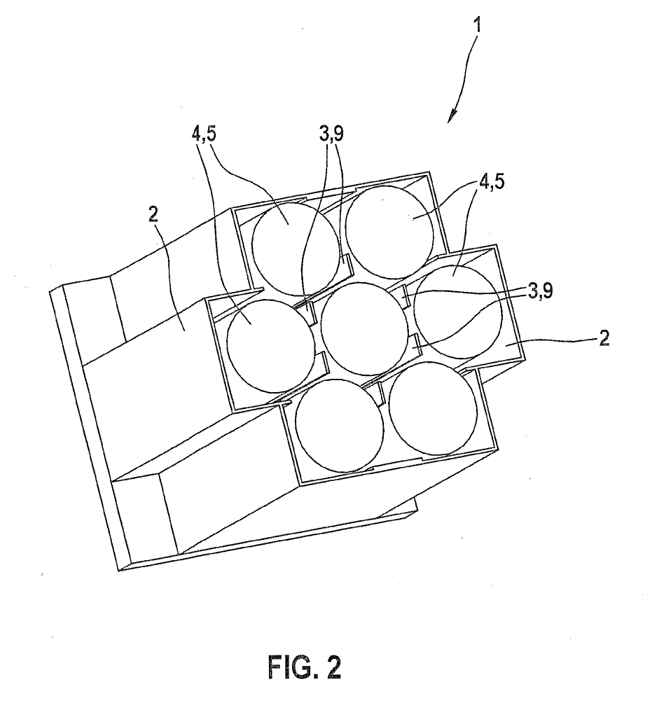

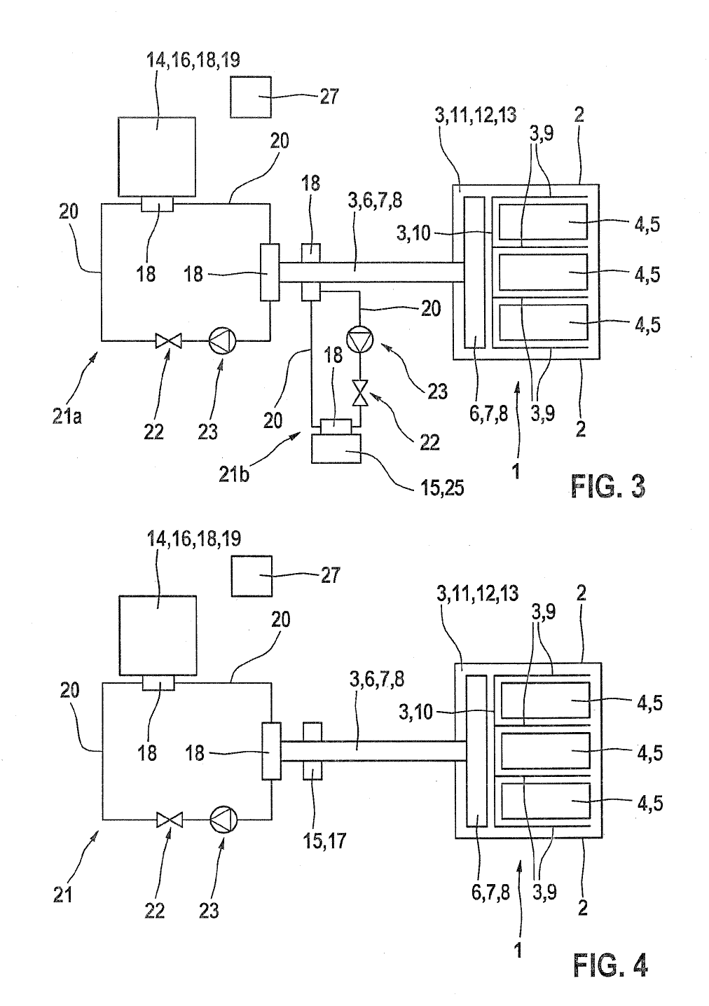

In FIG. 1, a perspective view of a housing 2 of a battery module 1 for receiving batteries 4 is shown. In FIG. 1, an upper wall of the housing 2 is not shown. The housing 2 comprises plastic, and inside the housing there are fins 9 of copper. Between the fins 9 and the housing 2, batteries 4 embodied as lithium-ion batteries 5 are disposed (FIG. 2). Electrical lines for carrying away and supplying electric current to the batteries 4 are not shown in FIGS. 1 and 2. The remaining hollow space inside the housing 2 between the batteries 4 is filled with a thermally conductive liquid 11, such as oil 12, in particular silicone oil 13 (FIG. 3). The fins 9 and the silicone oil 13 have a high thermal conductivity, so that the heat output at the surface of the batteries 4 can be well dissipated, and furthermore, only slight temperature differences between the batteries 4 of the battery module 1 occur. The fin 9 and the silicone oil 13 are means for tempering, that is, for cooling and/or heating, the batteries 4, because they conduct heat to the batteries 4 for heating the batteries 4 or carry heat away from the batteries 4 for cooling the batteries 4. The housing 2 is closed in fluid-tight fashion, and a membrane, not shown, enables a pressure equalization inside the housing 2, for instance in order to buffer different changes in volume occurring during heating and/or cooling. The liquid 11 is electrically nonconductive.

In FIG. 3, a schematic section is shown through a battery module 1 with a heat-exchanger tube 6 as its means 3 and with two fluid circuits 21 and 21a and 21b. Inside the housing 2 of the battery module 1, seven lithium-ion batteries 5 are disposed, of which only three lithium-ion batteries 5 are shown in FIG. 3 because of the sectional view. The fins 9 of copper are located between the lithium-ion batteries 5 and also between the lithium-ion batteries 5 and the housing 2. On an upper end of the lithium-ion batteries 5, the fins 9 are connected thermally and mechanically to a plate 10 of copper. The heat-exchanger tube 6, such as a heat pipe 7 or thermosiphon 8, is connected thermally and mechanically to the plate 10. The heat-exchanger tube 6 extends through the housing 2, and there are two heat transfer media 18 or heat exchangers 18 in the end region of the heat-exchanger tube 6 that is embodied outside the housing 2. Inside the fluid circuit 21, which is formed essentially by a line 20, through which a fluid, such as air or liquid, a valve 22 and a pump 23 are disposed. Also, a first fluid circuit 21a is thermally connected to a heat sink 14 by means of a heat transfer medium 18, and the second fluid circuit 21b is analogously connected by a heat transfer medium 18 to a heat source 15.

The heat sink 14, in the use of the battery module 1 in a motor vehicle 26, can for instance be an evaporator 16 of an air conditioning system 27 of the motor vehicle 26, or a heat transfer medium 18 for transferring heat to the ambient air, or a body 19 of the motor vehicle 26. Thus for cooling the batteries 4 in the housing 2, the first fluid circuit 21a is switched on; that is, the valve 22 is opened and the pump 23 is in operation. The fluid flowing through the line 20 absorbs heat at the heat transfer medium 18, which is disposed on the heat-exchanger tube 6, and outputs the heat to the heat sink 14 by means of the heat transfer medium 18. Thus the batteries 4 of the battery module 1 can be cooled. For heating the batteries 4 of the battery module 1, the first fluid circuit 21a is switched off; that is, the valve 22 is closed, and the pump 23 is switched off. The second fluid circuit 21b having the heat source 15 is switched on; that is, the valve 22 is opened, and the pump 23 is switched on. As a result, the heat made available by the heat source 15 is absorbed by the fluid in the line 20 and conducted to the heat transfer medium 18 on the heat-exchanger tube 6. The heat-exchanger tube 6 conducts the heat to the batteries 4 of the battery module 1; that is, the plate 10, fins 9 and silicone oil 13 are heated by the heat-exchanger tube 1. The control and/or regulation of the heating and/or cooling of the batteries 4 of the battery module 1 is effected by means of a control device, not shown. Temperature sensors, not shown, are also present, which for instance detect the temperature at the batteries 4, the heat transfer media 18, and the heat source 15 as well as the heat sink 14 and send them to their control unit, not shown. As the heat source 15, an internal combustion engine 25 of the motor vehicle 26 can for instance be used. As a result, no additional energy needs to be expended for heating the batteries 4.

In FIG. 4, a second embodiment of the battery module 1 is shown, having only one fluid circuit 21. The cooling of the batteries 4 of the battery module 1 is effected analogously to the first embodiment of FIG. 3. For heating the batteries 4 of the battery module 1, instead of the second fluid circuit 21b, only an electric heater 17 is used as the heat source 15. The electric heater 17 is disposed directly in the vicinity of the end of the heat-exchanger tube 6. For heating the batteries 4 of the battery module 1, the electric heater 17 merely needs to be switched on, so that by means of the plate 5, the fins 4, and the silicone oil 13, the batteries 4 can be heated by the heat-exchanger tube 6. Thus for heating the batteries 4, the electric heater 17 is switched on, and the fluid circuit 21 is switched off; that is, the valve 22 is closed, and the pump 23 is switched off. For cooling the batteries 4 of the battery module 1, in the second embodiment, the electric heater 17 is switched off and the fluid circuit 21 is put into operation; the valve 22 is opened, and the pump 23 is switched on. The heater 17 and optionally the fluid circuit 21 as well can be disposed for instance in a spare tire recess, in a trunk, or in the vicinity of a rear bench seat of the motor vehicle 26.

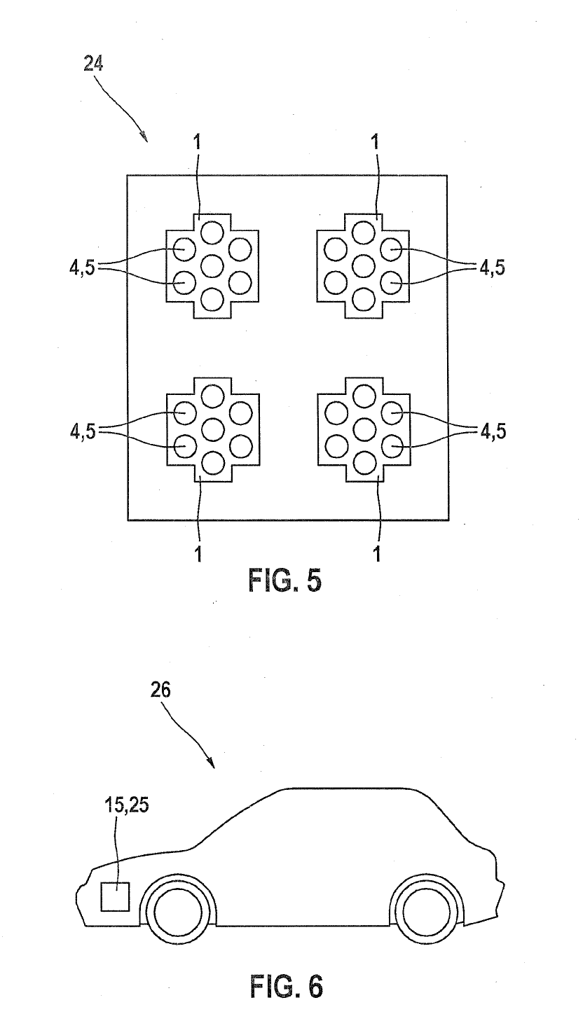

It is also possible for a plurality of battery modules 1 to be connected, to make a battery module system 24 of the invention (FIG. 5). In a battery module system 24, for instance for a passenger car or utility vehicle, with four battery modules 1 each with seven lithium-ion batteries 5, there are accordingly 28 lithium-ion batteries 5. The modular construction thus makes better scalability possible, since with the identical battery modules 1, different levels of electric power for various applications can easily be implemented.

In FIG. 6, a motor vehicle with an internal combustion engine 25 is shown. The internal combustion engine 25 serves as a heat source 15 and with it the heat, for instance from the cooling liquid, the motor oil, the transmission fluid, or the waste gas, is conducted to the fluid circuit 21 by means of a heat transfer medium 18 (not shown).

The details of the various exemplary embodiments can be combined in with one another, unless anything is said to the contrary.

Viewed overall, considerable advantages are associated with the battery module 1 of the invention, the battery module system 24 of the invention, and the motor vehicle 26 of the invention. For tempering, or in other words cooling and/or heating, the batteries 4, a heat-exchanger tube 6 is used, so that no moving parts, such as a fluid delivery device, for delivering a tempering fluid is required any longer. The energy expenditure for tempering the batteries 4 can be reduced as a result, and the space required for the battery module 1 can be reduced as well. Moreover, in use in a space station, because of the rotating elements that are present, there are no adverse effects on the spinning of the space station. The batteries 4 are disposed in the housing 2 with only minimal space between them, so that there is a high energy density of the battery module 1 per unit of volume; in other words, the battery module requires little space.

1-15. (canceled)

16. A battery module, comprising:
a housing;
at least one battery disposed in the housing; and
at least one means for tempering the at least one battery, which includes at least one heat-exchanger tube for conducting heat from and/or to the at least one battery.

17. The battery module as defined by claim 16, wherein between at least two batteries, there is at least one fin of a thermally conductive material, such as metal, in particular copper, and the at least one fin is connected thermally conductively to the at least one heat-exchanger tube.

18. The battery module as defined by claim 17, wherein at least two fins are connected thermally conductively to a plate made of a thermally conductive material, such as metal, and the plate is connected thermally conductively to the at least one heat-exchanger tube.

19. The battery module as defined by claim 16, wherein the at least one battery in the housing is disposed in a preferably electrically nonconductive liquid for thermal conduction.

20. The battery module as defined by claim 19, wherein the liquid is an oil, such as silicone oil.

21. The battery module as defined by claim 16, wherein the housing at least partly comprises plastic or metal.

22. The battery module as defined by claim 16, wherein the at least one battery is a lithium-ion battery.

23. The battery module as defined by claim 16, wherein the at least one heat-exchanger tube is a heat pipe or a thermosiphon.

24. A battery module system having a plurality of battery modules, characterized in that the battery module system includes at least one battery module as defined by claim 16.

25. The battery module as defined by claim 24, wherein at least two battery modules are connected thermally conductively to one another by means of the at least one heat-exchanger tube, for tempering the at least one battery.

26. A motor vehicle which includes at least one battery module system as defined by claim 24.

27. A motor vehicle which includes at least one battery module system as defined by claim 25.

28. A motor vehicle which includes at least one battery module as defined by claim 16.

29. The motor vehicle as defined by claim 28, wherein for cooling the at least one battery, the at least one heat-exchanger tube is connected or connectable thermally conductively to a heat sink, and/or for heating the at least one battery, the at least one heat-exchanger tube is connected or connectable thermally conductively to a heat source.

30. The motor vehicle as defined by claim 26, wherein for cooling the at least one battery, the at least one heat-exchanger tube is connected or connectable thermally conductively to a heat sink, and/or for heating the at least one battery, the at least one heat-exchanger tube is connected or connectable thermally conductively to a heat source.

31. The motor vehicle as defined by claim 27, wherein for cooling the at least one battery, the at least one heat-exchanger tube is connected or connectable thermally conductively to a heat sink, and/or for heating the at least one battery, the at least one heat-exchanger tube is connected or connectable thermally conductively to a heat source.

32. The motor vehicle as defined by claim 30, wherein the heat sink is an evaporator of an air conditioning system and/or is a heat transfer medium for transferring heat to the ambient air and/or is a body of the motor vehicle.

33. The motor vehicle as defined by claim 30, wherein the heat source is an electric heater and/or a heat transfer medium for transferring waste heat out of an internal combustion engine of the motor vehicle.

34. The motor vehicle as defined by claim 32, wherein the heat source is an electric heater and/or a heat transfer medium for transferring waste heat out of an internal combustion engine of the motor vehicle.

35. The motor vehicle as defined by claim 30, wherein the heat sink and/or the heat source is connectable thermally conductively to the at least one heat-exchanger tube by means of heat convection, for instance with a fluid circuit, so that the heat convection can preferably be switched on and off.
